(19) United States
(12) Patent Application Publication
(10) Pub. No.: US 2014/0051028 A1
(43) Pub. Date: Feb. 20, 2014

(54) PROPELLANT COMPATIBLE COMPONENT FOR COMBUSTION DEVICE

(71) Applicants: Daniel Edward Matejczyk, Canoga Park, CA (US); Daniel P. Cap, Canoga Park, CA (US)

(72) Inventors: Daniel Edward Matejczyk, Canoga Park, CA (US); Daniel P. Cap, Canoga Park, CA (US)

(21) Appl. No.: 13/587,084

(22) Filed: Aug. 16, 2012

(51) Int. Cl. F23L 7/00; B23K 15/00; F23D 14/62

(52) U.S. Cl. 431/2; 431/354; 219/121.2

(57) ABSTRACT

This disclosure relates to a component formed using an additive manufacturing process. Further disclosed is a method for providing a component for use with a combustion device. In the method, a component formed using an additive manufacturing process is provided. The component is left with a plurality of powder particles only partially fused to an internal passage thereof as a result of the additive manufacturing process. The method further includes removing the partially fused powder particles from the internal passage with a thermal energy process.

### BACKGROUND

Components for combustion devices, such as rocket engines and coal gasifiers, have been built using known techniques. Certain components, such as injectors, that convey a propellant, such as a fuel or oxidizer, are typically very clean and have an excellent surface finish in order to function properly. One known method for forming such components is injection molding.

### SUMMARY

A method for providing a component for a combustion device according to one embodiment of the present disclosure includes providing a component formed using an additive manufacturing process. The additive manufacturing process leaves the component with a plurality of powder particles only partially fused to an internal passage thereof. The method further includes removing the partially fused powder particles from the internal passage using a thermal energy process.

In a further non-limiting embodiment of any of the examples herein, the partially fused powder particles are at least one of burrs and flash within the internal passage.

In a further non-limiting embodiment of any of the examples herein, the internal passage is arranged to convey a propellant.

In a further non-limiting embodiment of any of the examples herein, the component is an injector.

In a further non-limiting embodiment of any of the examples herein, the propellant includes liquid oxygen.

In a further non-limiting embodiment of any of the examples herein, the combustion device is selected from the group consisting of a rocket engine and a coal gasifier.

In a further non-limiting embodiment of any of the examples herein, the powder particles are alloy particles.

In a further non-limiting embodiment of any of the examples herein, the removing step includes providing the component in a chamber, pressurizing the chamber with a mixture or oxidizer and fuel, and igniting the contents of the chamber.

In a further non-limiting embodiment of any of the examples herein, the additive manufacturing process leaves the internal passage with an organic contaminant, and wherein the removing step includes removing the contaminant with the thermal energy process.

In a further non-limiting embodiment of any of the examples herein, the removed partially fused particles have a height to width ratio of about 2:1, and wherein contaminant is reduced to a level of about 1 milligram of nonvolatile residue per square foot of surface area of the internal passage.

A method for operating a combustion device according to another embodiment of the present disclosure includes providing a component formed using an additive manufacturing process. The additive manufacturing process leaves the component with asperities on an internal passage thereof, and the internal passage have been treated with a thermal energy process to remove the asperities. The method further includes establishing a flow of a propellant through the internal passage that has been treated with the thermal energy process.

In a further non-limiting embodiment of any of the examples herein, the asperities include at least one of burrs and flash, the asperities including a plurality of powder particles only partially fused to the internal passage.

In a further non-limiting embodiment of any of the examples herein, the combustion device is selected from the group consisting of a rocket engine and a coal gasifier.

In a further non-limiting embodiment of any of the examples herein, the propellant includes liquid oxygen.

In a further non-limiting embodiment of any of the examples herein, the component is an injector.

In a further non-limiting embodiment of any of the examples herein, the internal passage is configured to direct liquid oxygen throughout the combustion device.

A combustion device according to yet another embodiment of the present disclosure includes an electron beam formed component having an internal passage. The internal passage is configured to route a propellant within the interior of the component. The component is treated with a thermal energy process to remove asperities on the internal passage remaining from the electron beam process, such that the internal passage is substantially free of the asperities.

In a further non-limiting embodiment of any of the examples herein, the asperities include at least one of burrs and flash.

In a further non-limiting embodiment of any of the examples herein, the propellant includes liquid oxygen.

In a further non-limiting embodiment of any of the examples herein, the component is selected from the group consisting of an injector, a pump, a conduit, and a valve.

These and other features of the present disclosure can be best understood from the following drawings and detailed description.

### BRIEF DESCRIPTION OF THE DRAWINGS

The drawings can be briefly described as follows:

FIG. 1 is a schematic view of an example combustion device, here illustrated as a rocket engine.

FIG. 2 illustrates an example process of producing a component for use in the engine of FIG. 1.

FIG. 3 schematically illustrates an example additive manufacturing machine.

FIG. 4 illustrates an example component formed using an additive manufacturing process.

FIG. 5 schematically illustrates the component of FIG. 4 undergoing a thermal energy process.

FIG. 6 illustrates the component of FIG. 4 after having undergone the thermal energy process illustrated in FIG. 5.

### DETAILED DESCRIPTION

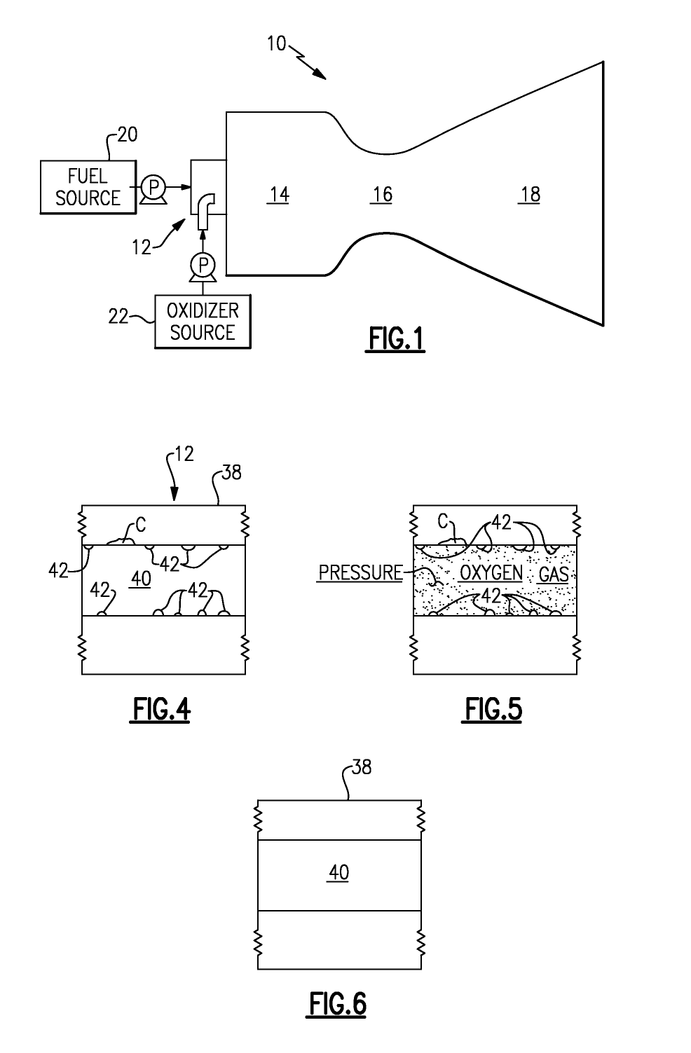

FIG. 1 illustrates a combustion device, which in this example is a rocket engine 10. The rocket engine 10 includes an injector 12, a combustion chamber 14, a throat 16, and a nozzle 18. In this example, the injector 12 is in communication with propellants provided by a fuel source 20 and an oxidizer source 22. The fuel source and oxidizer source 20, 22 are each optionally in communication with one or more of a plurality of pumps P. For the purposes of this disclosure, the term “propellant” includes fuel, oxidizer, and also refers to the mixture of fuel and oxidizer. In one example, the oxidizer provided by the oxidizer source is liquid oxygen (LOx).

This disclosure is not limited to any particularities of the illustrated rocket engine 10. Further, while a rocket engine 10 is illustrated, this disclosure is not limited to rocket engines, and extends to other combustion devices, such as coal gasifiers.

Components of the rocket engine 10, such as the injector 12, include complex internal structures, such as internal passages, which are configured to route propellant to the combustion chamber 14. One exemplary method for building components with such internal structures, such as the injector 12, is additive manufacturing.

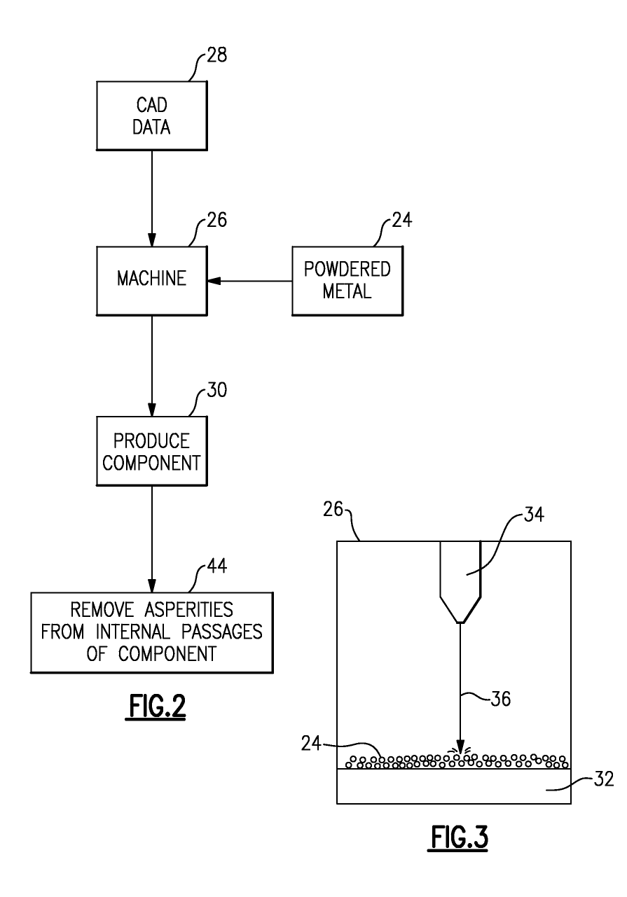

An example additive manufacturing process is illustrated across FIGS. 2 and 3. In the example, a powdered material 24 used for forming a component is provided within a machine 26. For example, the powdered material 24 is a metal or a metal alloy. Using an additive manufacturing technique, the machine 26 deposits multiple layers of powdered metal onto one another. The layers are fused together with reference to computer aided drafting (CAD) data 28, which represents a particular component design. At 30, the component is produced by building up layers of the fused powder metal according to the CAD data 28.

FIG. 3 schematically illustrates an example additive manufacturing machine 26. In the example, powdered material 24 is provided on a bed 32 and is fused by an additive manufacturing process. As illustrated, the additive manufacturing process is an electron beam fusing process, including an electron beam source 34 which generates an electron beam 36. In another example, the additive manufacturing process is a direct metal laser sintering process. It should be understood that this disclosure is not limited to the particularities of the additive manufacturing process.

As a result of the additive manufacturing process, the internal passages of such a component are often left with asperities, such as burrs and flash, which are caused by metal particles, such as alloy particles, that only became partially fused to the remaining particles.

An example of a portion of an internal passage 40 of an injector 12 formed using additive manufacturing is illustrated in FIG. 4. The injector 12 includes an outer surface 38 and the internal passage 40. The internal passage 40 is left with asperities 42, which can result from the incomplete fusion between particles during the additive manufacturing process. The internal passages could additionally have contaminant residue, such as the contaminant C, which could be oil residue or other organic material, as examples.

The outer surface 38 of the injector 12 would also have been left with asperities as well, however the outer surface 38 is relatively easy to clean because it is directly accessible. The internal passages 40, on the other hand, cannot be readily accessed. To prepare the internal passage 40 for interaction with a propellant, the asperities 42 and contaminants C are removed. Turning back to FIG. 2, this removal is represented at step 44.

In one example, the removal step 44 includes using a thermal energy method. The thermal energy method includes placing the injector 12 within a sealed chamber, which is then pressurized with oxygen and a second gas, such as natural gas. The two gases are mixed in a ratio that permits a controlled combustion. The chamber is then ignited, and this ignition creates a large temperature and pressure climb within the chamber, which is readily absorbed by the main body of the injector 12, but not the asperities 42 or the contaminants C. The combustion of the fuel and oxidizer mixture thus removes the asperities 42 and contaminants C from the internal passage 40, without damaging the remainder of the injector 12. In FIG. 5, the injector 12 is undergoing a thermal energy process. As a result of the process, the injector 12 is provided with a clean internal passage 40, as illustrated in FIG. 6, such that the internal passage 40 is free, or at least substantially free of asperities 42 and contaminants C. As used herein, the term substantially free means that asperities 42 having a certain height to width ratio such as about 2:1 are eliminated, and contaminants C are reduced to levels required by cleaning specifications, such as about 1 milligram of nonvolatile residue per square foot of surface area.

While FIGS. 4-6 reference the injector 12, other components that contact or convey propellant also come within the scope of this disclosure. As examples, this disclosure extends to various elements within the pumps P of FIG. 1, and any other structural elements, such as valves and conduits.

Accordingly, this disclosure provides the ability to manufacture components, which contact or convey propellant, using additive manufacturing techniques. Components which have previously not been candidates for manufacture by additive manufacturing can now be made by additive manufacturing with a high degree of confidence that a propellant will not negatively interact with asperities and contaminants (e.g., by igniting the contaminants or dislodging the asperities) within the internal passages thereof.

Although the different examples have the specific components shown in the illustrations, embodiments of this invention are not limited to those particular combinations. It is possible to use some of the components or features from one of the examples in combination with features or components from another one of the examples.

One of ordinary skill in this art would understand that the above-described embodiments are exemplary and non-limiting. That is, modifications of this disclosure would come within the scope of the claims. Accordingly, the following claims should be studied to determine their true scope and content.

What is claimed is:

1. A method for providing a component for a combustion device, the method comprising:
providing a component formed using an additive manufacturing process, the additive manufacturing process leaving the component with a plurality of powder particles only partially fused to an internal passage thereof; and
removing the partially fused powder particles from the internal passage using a thermal energy process.

2. The method as recited in claim 1, wherein the partially fused powder particles are at least one of burrs and flash within the internal passage.

3. The method as recited in claim 1, wherein the internal passage is arranged to convey a propellant.

4. The method as recited in claim 3, wherein the component is an injector.

5. The method as recited in claim 4, wherein the propellant includes liquid oxygen.

6. The method as recited in claim 1, wherein the combustion device is selected from the group consisting of a rocket engine and a coal gasifier.

7. The method as recited in claim 1, wherein the powder particles are alloy particles.

8. The method as recited in claim 1, wherein the removing step includes providing the component in a chamber, pressurizing the chamber with a mixture or oxidizer and fuel, and igniting the contents of the chamber.

9. The method as recited in claim 1, wherein the additive manufacturing process leaves the internal passage with an organic contaminant, and wherein the removing step includes removing the contaminant with the thermal energy process.

10. The method as recited in claim 9, wherein the removed partially fused particles have a height to width ratio of about 2:1, and wherein the contaminant is reduced to a level of about 1 milligram of nonvolatile residue per square foot of surface area of the internal passage.

11. A method for operating a combustion device, the method comprising:
providing a component formed using an additive manufacturing process, the additive manufacturing process leaving the component with asperities on an internal passage thereof, the internal passage having been treated with a thermal energy process to remove the asperities; and
establishing a flow of a propellant through the internal passage that has been treated with the thermal energy process.

12. The method as recited in claim 11, wherein the asperities include at least one of burrs and flash, the asperities including a plurality of powder particles only partially fused to the internal passage.

13. The method as recited in claim 11, wherein the combustion device is selected from the group consisting of a rocket engine and a coal gasifier.

14. The method as recited in claim 13, wherein the propellant includes liquid oxygen.

15. The method as recited in claim 14, wherein the component is an injector.

16. The method as recited in claim 15, wherein the internal passage is configured to direct liquid oxygen throughout the combustion device.

17. A combustion device comprising:
an electron beam formed component having an internal passage, the internal passage configured to route a propellant within the interior of the component, the component treated with a thermal energy process to remove asperities on the internal passage remaining from the electron beam process such that the internal passage is substantially free of the asperities.

18. The combustion device as recited in claim 17, wherein the asperities include at least one of burrs and flash.

19. The combustion device as recited in claim 17, wherein the propellant includes liquid oxygen.

20. The combustion device as recited in claim 17, wherein the component is selected from the group consisting of an injector, a pump, a conduit, and a valve.
